(19) United States
(12) Patent Application Publication
(10) Pub. No.: US 2017/0104391 A1
(43) Pub. Date: Apr. 13, 2017

(54) INCREASING THE APPARENT POWER OF GAS-COOLED TURBOGENERATORS BY WAY OF INCREASED PRESSURE IN THE HOUSING

(71) Applicant: SIEMENS AKTIENGESELLSCHAFT, MÜNCHEN (DE)

(72) Inventor: THORSTEN KROL, DUISBURG (DE)

(21) Appl. No.: 15/285,508

(22) Filed: Oct. 5, 2016

(30) Foreign Application Priority Data
Oct. 7, 2015 (DE) 10 2015 219 359.4

(51) Int. Cl. H02K 9/10; H02K 5/04

(52) U.S. Cl. CPC H02K 9/10; H02K 5/04

(57) ABSTRACT

Provided is an improved shaft seal and/or modifications of the outer housing, an air-cooled generator can be modified in such a way that it can be operated at an overpressure and a higher power output can be achieved. Disclosed is a first embodiment of the invention for increasing gas pressure in a generator through use of shaft seals; a second embodiment of the invention for increasing gas pressure in a generator through use of reinforcing elements; and a third embodiment of the invention for increasing gas pressure in a generator through use of outer housing thickness.

### CROSS-REFERENCE TO RELATED APPLICATIONS

This application claims priority German application No. 10 2015 219 359.4 having a filing date of Oct. 7, 2015, the entire contents of which are hereby incorporated by reference.

### FIELD OF TECHNOLOGY

The following relates to increasing the power of air-cooled generators by way of an increased pressure in the housing, in particular in the case of servicing, and to a generator.

### BACKGROUND

On account of operating conditions which change over time at the customers of the energy suppliers, it occurs frequently that existing power plants can produce and sell more real power. In order to make this possible, performance increases can be achieved at the turbines by way of an increase in the degrees of efficiency by means of different technologies, an increase of the order of magnitude of greater than 2% often being achieved.

In new power plant business, however, the customers take care to purchase the new components such that they are tailored as precisely as possible to the current requirements, in order to keep the investment costs there as low as possible. This leads to the electric power plant generators being installed with the required power and as a rule not having a margin with regard to the apparent power, with the result that a further increase in the output power by way of an increase in the degree of efficiency is no longer possible. In order to nevertheless make business possible with power increases of gas turbines or steam turbines, a possibility has to be found for increasing the output-side real power with acceptable outlay. It is to be noted here that the gas turbine generates merely real power, but the turbogenerator generates real power and idle power. Here, these are usually limited thermally in the generator power diagram. Here, what is known as the power factor corresponds to the cosine of the angle between the real power and the apparent power in the power diagram.

Up to now, the possibility of increasing power of air-cooled turbogenerators has been possible in the following ways:

A) Slight Increase in the Real Power—

A small increase in the real power is almost always possible with restriction of the idle power or by way of restriction of the power factor, until the latter reaches the value 1. In this case, the maximum real power of the generator is reached without modification of the generator. This limit tends to be theoretical, however, since the power plant also requires idle power for operating itself and therefore has to draw said blind power from the power grid.

B) Large Increase in the Real Power—

If a greater increase in the real power without generation of idle power is required, the generator is in the thermal boundary of the stator winding defined by the insulation material class. New stator winding and possibly further measures such as checking of the rotor winding for hot spots and elimination thereof are usually required, in order to ensure the long term operation of the generator with consideration of the higher thermal and mechanical loading of the generator. This often means a considerable time and financial outlay, with the result that the economic viability of the measures is questionable.

C) Increase in the Apparent Power with Constant Idle Power—

An increase in the apparent power of the turbogenerator can be brought about by way of an optimization in terms of cooling technology of the hot spots on the stator and/or on the rotor or by way of carrying out a plurality of measures for reducing the losses of individual components. This is often very expensive and/or not economically possible partially owing to design in the case of necessary new stator winding.

D) Increase in the Apparent Power with a Constant Power Factor—

A power increase in the apparent power with a constant power factor is possible only by way of improving the cooling of the generator. To this end, a “chiller” or, in warm, dry areas, an “evaporative cooler” could be used which, however, are major interventions in the power plant process technology and are very expensive.

The solution for possible power increases with the greatest benefit for the power plant operators would be variant D, in which all limits owing to cooling technology can be shifted apart from the stability limit.

### SUMMARY

An aspect relates to increasing the generator power, without the abovementioned problems.

Further advantageous measures are listed in the subclaims, which measures can be combined with one another as desired, in order to achieve further advantages.

### BRIEF DESCRIPTION

Some of the embodiments will be described in detail, with reference to the following figures, wherein like designations denote like members, wherein:

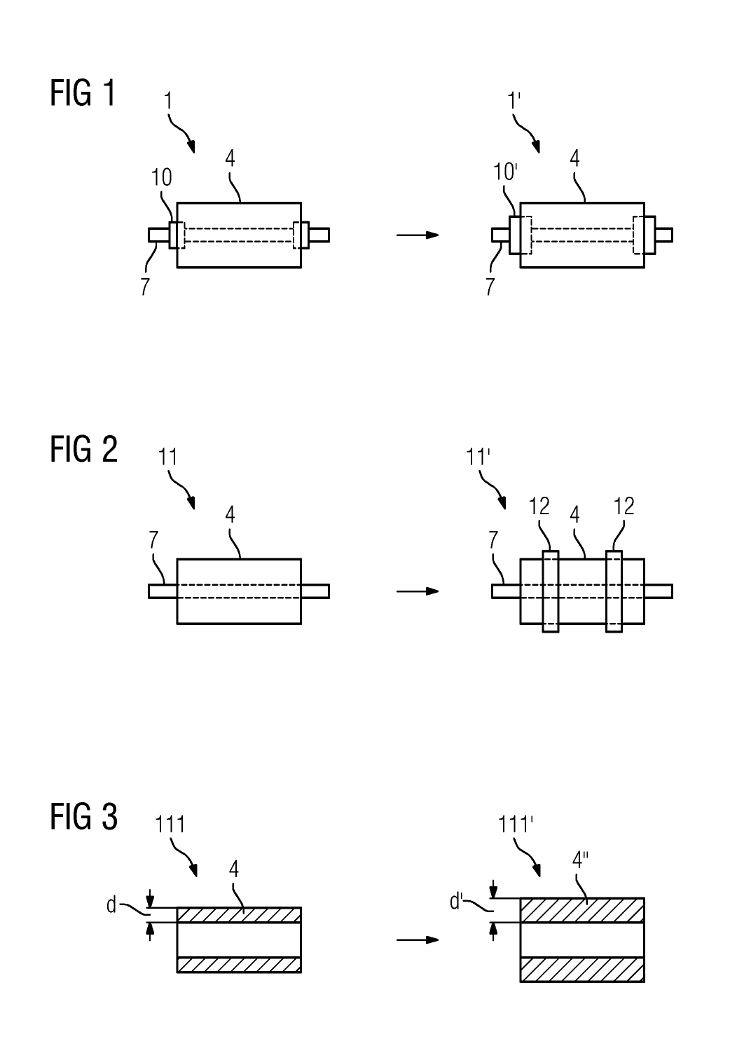

FIG. 1 shows a first embodiment of the invention for increasing gas pressure in a generator through use of shaft seals;

FIG. 2 shows a second embodiment of the invention for increasing gas pressure in a generator through use of reinforcing elements; and

FIG. 3 shows a third embodiment of the invention for increasing gas pressure in a generator through use of outer housing thickness.

The description in the figures represents merely exemplary embodiments of the invention.

### DETAILED DESCRIPTION

The solution for a power increase is an increase in the gas pressure, in particular the air pressure, in the generator 1, 11, 111 and its outer housing 4.

As a result, the cooling mass flow of the gas or the air in the generator 1′, 11′, 111′ is increased, as a result of which the heat can be dissipated in an improved manner, the friction losses in the cooling gas being increased slightly, however.

Power increases of up to 16% or more can be achieved in a manner which is dependent on the gas inner pressure in the generator 1′, 11′, 111′.

In order for it to be possible to operate the generator 1′, 11′, 111′ at overpressure, firstly a shaft seal 10′ (FIG. 1) can be introduced which withstands the higher cooling gas pressure, in particular air pressure here, that is to say at least 1.20 bar (120 kPa), in particular at least 1.50 bar (150 kPa) or a pressure in the outer housing 4 which is higher by at least 10%, in particular at least 20% in comparison with the ambient pressure.

The outer housing 4 of the generator 11 can likewise be reinforced by way of reinforcing elements 12, in particular in the case of servicing (FIG. 2), with the result that a mechanically reinforced generator 11′ is produced.

The reinforcing elements 12 are T-beams or I-beams and are preferably welded onto the outer housing.

The power increase by way of a housing change 4→4″ (FIG. 3) would also be comparatively rapid and simple using the existing active part as a service feature. The modified outer housing 4″ of the changed generator 111″ is preferably thicker (d′>d) or preferably of greater mechanical strength than the previous outer housing 4 (FIG. 3, left-hand side).

Furthermore, it has to be checked whether there is sufficient potential in the existing current supply of the exciter of the generator 1′, 11′, 111′ to be able to supply the required higher exciter current.

Complicated new stator and/or rotor winding is dispensed with by using this solution. Furthermore, this solution can be used completely independently of the generator design of the active part components.

Although the present invention has been described in detail with reference to the preferred embodiment, it is to be understood that the present invention is not limited by the disclosed examples, and that numerous additional modifications and variations could be made thereto by a person skilled in the art without departing from the scope of the invention.

It should be noted that the use of “a” or “an” throughout this application does not exclude a plurality, and “comprising” does not exclude other steps or elements. Also elements described in association with different embodiments may be combined. It should also be noted that reference signs in the claims should not be construed as limiting the scope of the claims.

1. A method for increasing the power of a generator,
in the case of servicing,
a gas being used for cooling in the interior of the generator,
in which method a shaft seal of the generator against a positive pressure in the outer housing of the generator of at least 120 kPa,
or
ambient pressure which is at least 10% higher,
is installed or replaced,
and/or
the outer housing of the generator is reinforced by way of reinforcing elements,
and/or
the outer housing of the generator is replaced by a housing of greater mechanical strength, and the generator is operated at a gas overpressure.

2. A generator which has a shaft seal against positive pressure in the outer housing,
and/or
the outer housing of which has reinforcing elements,
and/or
the outer housing of which has been replaced by or has an outer housing which is thicker or of greater mechanical strength.

3. The generator as claimed in claim 2,
in which the shaft seal seals against at least 120 kPa.

4. The method or generator as claimed in claim 1,
in which the reinforcing elements are a T-beam or I-beam, and
are welded or brazed, onto the outer housing.
